(19) United States
(12) Patent Application Publication
(10) Pub. No.: US 2026/0361157 A1
(43) Pub. Date: Nov. 12, 2026

(54) STATOR CAP FOR ELECTRIC MOTOR

(71) Applicant: MILWAUKEE ELECTRIC TOOL CORPORATION, Brookfield, WI (US)

(72) Inventor: Caleb W. Colbert, Slinger, WI (US)

(21) Appl. No.: 19/671,992

(22) Filed: May 8, 2026

Related U.S. Application Data
(60) Provisional application No. 63/804,364, filed on May 12, 2025.

(51) Int. Cl. H02K 1/20; H02K 1/14; H02K 9/18; H02K 9/26

(52) U.S. Cl. CPC H02K 1/20; H02K 1/146; H02K 9/18; H02K 9/26

(57) ABSTRACT

An electric motor includes a stator assembly including a stator core having a plurality of stator teeth and a plurality of stator coils, each stator coil wound about one of the stator teeth, a rotor assembly positioned within the stator assembly and rotatable relative thereto, and a stator cap coupled to the stator assembly and configured to direct an airflow through the stator assembly, the stator cap including a passage having a first port and a second port, the second port facing the stator assembly, the airflow is directed through the passage in a first direction from the first port to the second port or in a second direction from the second port to the first port.

### CROSS-REFERENCE TO RELATED APPLICATIONS

This application claims priority to U.S. Provisional Patent Application No. 63/804,364, filed on May 12, 2025, the entire content of which is incorporated herein by reference.

### FIELD OF THE INVENTION

The present invention relates to electric motors, and more particularly, to cooling arrangements for electric motors.

### BACKGROUND OF THE INVENTION

Heat generation in an electric motor often occurs in the stator coils. The stator surrounding the stator coils receives the heat generated by the stator coils by thermal conduction. Removal of heat generated by the stator coils is often accomplished by coupling a fan to the output shaft of the rotor to generate an airflow around the stator. Additionally, the air flow generated to travel around the motor is often allowed to recirculate through the stator, which raises the effective temperature of the cooling medium (e.g., the airflow), thereby reducing the effectiveness of heat removal by thermal convection.

Use of a cooling fan coupled to the output shaft of the rotor introduces several further inefficiencies. A cooling fan that is coupled to the output shaft of the rotor does not generate an airflow when the motor is stopped and therefore does not cool the motor when the motor is not running. For applications where the stator coils generate a substantial amount of heat, further cooling while the motor is not running cannot be accomplished with a fan coupled to the rotor. The fan also cannot be optimized for generating a unidirectional airflow (e.g., toward the motor) when the motor is operable in both directions. A further shortcoming of a cooling fan is that a unidirectional airflow, especially a filtered airflow, requires additional supporting components or a mounting, chassis, or other enclosure to support the motor.

### SUMMARY OF THE INVENTION

The present disclosure provides, in one aspect, an electric motor including: a stator assembly including a stator core having a plurality of stator teeth and a plurality of stator coils, each stator coil wound about one of the stator teeth; a rotor assembly positioned within the stator assembly and rotatable relative thereto; and a stator cap coupled to the stator assembly and configured to direct an airflow through the stator assembly, the stator cap including a passage having a first port and a second port, the second port facing the stator assembly, the airflow is directed through the passage in a first direction from the first port to the second port or in a second direction from the second port to the first port.

The present disclosure provides, in another aspect, an electric motor including: a stator assembly including a stator core having a plurality of stator coils; a rotor assembly positioned within the stator assembly and rotatable relative thereto; and a stator cap coupled to the stator assembly and configured to receive an airflow, the stator cap including a plurality of ports for directing the airflow toward the stator assembly.

The present disclosure provides, in another aspect, an electric motor including: a stator assembly including a stator core having a plurality of stator coils; a rotor assembly rotatably coupled to the stator assembly; and a stator cap coupled to the stator assembly and configured to direct an airflow through the stator assembly, the stator cap including a passage having a first port configured to receive the airflow and a second port facing the stator assembly and configured to direct the airflow toward the stator assembly, the second port including a plurality of discrete ports.

Other features and aspects of the invention will become apparent by consideration of the following detailed description and accompanying drawings.

### BRIEF DESCRIPTION OF THE DRAWINGS

FIG. 1 is an exploded perspective view of the stator cap coupled to a portion of a stator of a motor assembly.

FIG. 2 is a section view of the stator cap of FIG. 1 coupled to a portion of a motor assembly.

FIG. 3 is a perspective view of the stator cap of FIG. 1.

FIG. 4 is another perspective view of the stator cap of FIG. 1.

FIG. 5 is a section view of the stator cap of FIG. 1.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting.

### DETAILED DESCRIPTION

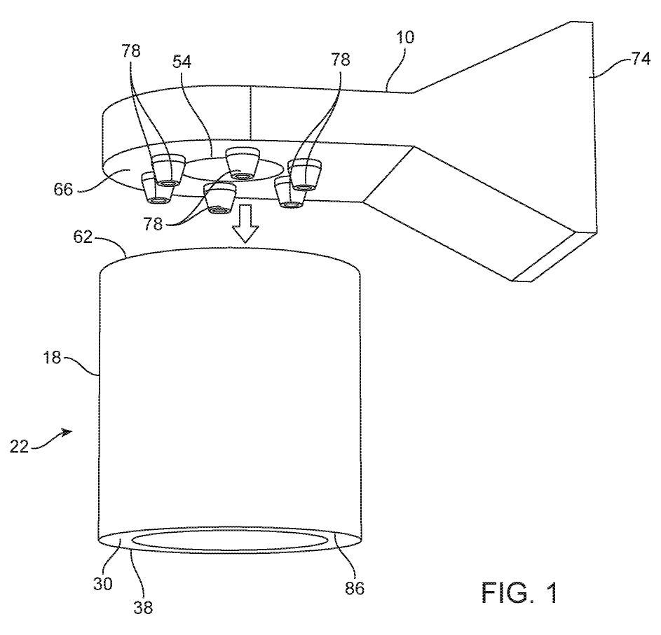

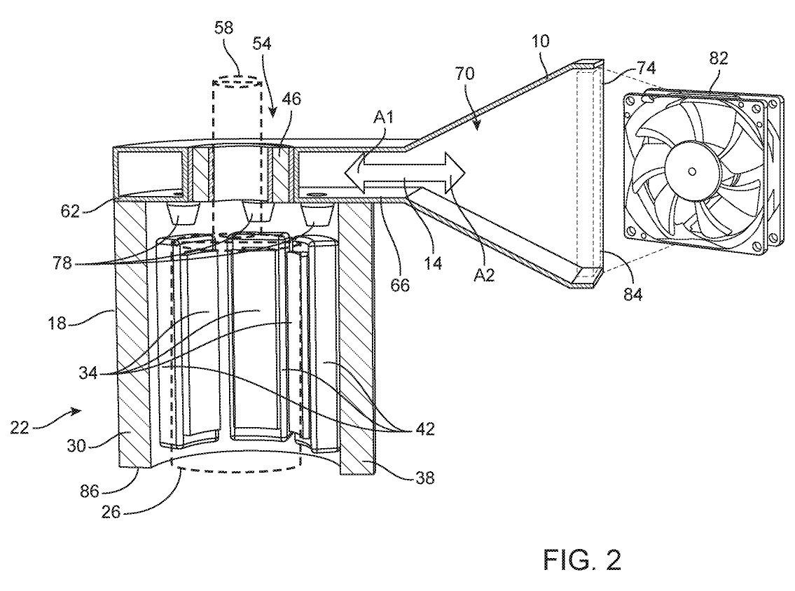

FIGS. 1-2 illustrate a stator cap 10 configured to direct an airflow (represented by arrow 14) through the stator assembly 18 of an electric motor 22. The electric motor 22 of the present embodiment is a brushless direct current (“DC”) motor that includes a stator assembly 18 and a rotor assembly 26 that is coupled to the stator assembly 18 to rotate relative to the stator assembly 18. The electric motor 22 is illustrated as an inner-rotor style motor assembly in which the rotor assembly 26 is disposed at least partially within the stator assembly 18. In other embodiments, the motor assembly may be configured as an outer-rotor, or outrunner, motor in which the rotor assembly is positioned at least partially surrounding the stator assembly. The stator assembly 18 includes a stator core 30 having stator teeth 34 that extend inwardly from the cylindrical portion 38 of the stator core 30. A stator coil 42 is wound about each of the stator teeth 34. The rotor assembly 26 is positioned within the stator assembly 18 and includes a rotor bearing 46 (e.g., coupled to an output shaft) that rotatably supports the rotor assembly 26 for rotation relative to the stator assembly 18. A stator cap 10 is coupled to the stator assembly 18 and includes an accommodation space 54. The accommodation space 54 receives the rotor bearing 46 to rotationally support the rotor assembly 26 and in some embodiments, allow the output shaft 58 of the rotor assembly 26 to pass through the stator cap 10.

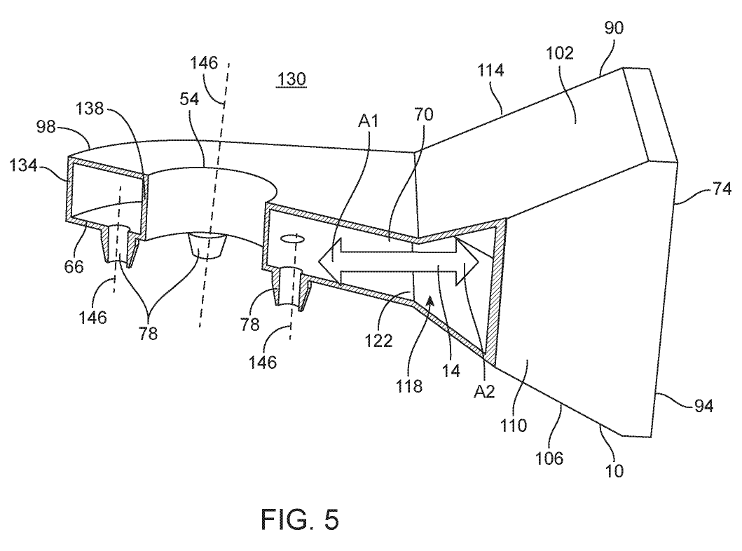

The stator cap 10 is coupled to an end 62 of the stator assembly 18. An external surface (e.g., lower wall 66) of the stator cap 10 covers the end 62 of the stator assembly 18 to at least partially, and in the present embodiment, block entirely another airflow external to the stator cap 10 from traveling through the stator assembly 18 from the end 62 of the stator assembly 18 to which the stator cap 10 is coupled. The stator cap 10 is configured to direct the airflow 14 through the stator assembly 18 for cooling the stator assembly 18 regardless of the direction of operation of the electric motor 22. The stator cap 10 includes a passage 70 that conveys the airflow 14 between a first port 74 of the passage 70 and a second port 78 of the passage 70 facing the stator assembly 18. The airflow 14 is directed through the passage 70 in either a first direction A1 (FIGS. 2, 5) from the first port 74 to the second port 78, or in a second direction A2 (FIGS. 2, 5) from the second port 78 to the first port 74. The airflow 14 in either the first direction or the second direction is directed through the stator assembly 18. In the present embodiment, the first port 74 is a single port and the second port 78 is configured as a plurality of discrete ports (e.g., six ports), with the number of discrete ports 78 corresponding to the number of stator coils 42 and stator teeth 34 of the stator assembly 18. Airflow traveling in the first direction from the first port 74 to the second port 78 exits the second port 78 and is directed to the stator assembly 18 to cool the stator assembly 18. Each of the discrete ports of the second port 78 of the present embodiment is directed to one of the stator coils 42. In other embodiments, each of the discrete ports of the second port 78 may be directed to the space between the stator coils. In still other embodiments, the stator cap may include a number of discrete outlets forming the second outlet 78 that is greater than or less than the number of stator coils. Airflow traveling in the second direction from the second port 78 to the first port 74 travels through the stator assembly 18 to the second port 78 and through the passage 70 to the first port 74.

An airflow generating device (e.g., a fan 82) may be coupled to the stator cap 10 to generate the cooling airflow 14 directed through the stator cap 10 and the stator assembly 18. In one embodiment, the fan 82 is coupled adjacent to and external from the first port 74. In another embodiment, the fan may be positioned within the inlet defined by the first port 74. In yet another embodiment, the fan may be positioned at the end 86 of the stator assembly 18 opposite the stator cap 10 and the airflow 14 generated by the fan 82 draws air into the stator cap 10 through the first port 74. In one embodiment, the airflow 14 generated through the stator cap 10 flows in the first direction A1 as a result of the fan 82 operating in a first rotational direction and the airflow 14 flows in the second direction A2 as a result of the fan 82 operating in a second rotational direction that is opposite to the first rotational direction of the fan 82. In other embodiments, the direction of the airflow may be dependent on a rotational direction of the rotor assembly 26 and a fan coupled to the output shaft 58. The stator cap 10 may include a filter 84 positioned in the passage 70 between the first port 74 and the second port 78 (e.g., adjacent to or coupled to the first port 74) to remove dust or other particulate from the airflow thereby reducing the amount of unwanted debris directed through the electric motor. In other embodiments, the filter 84 may be provided remote from the stator assembly, for instance, coupled to a sealed housing surrounding the stator assembly 18 to filter the airflow prior to the airflow entering the stator assembly (e.g., when the airflow travels in the second direction).

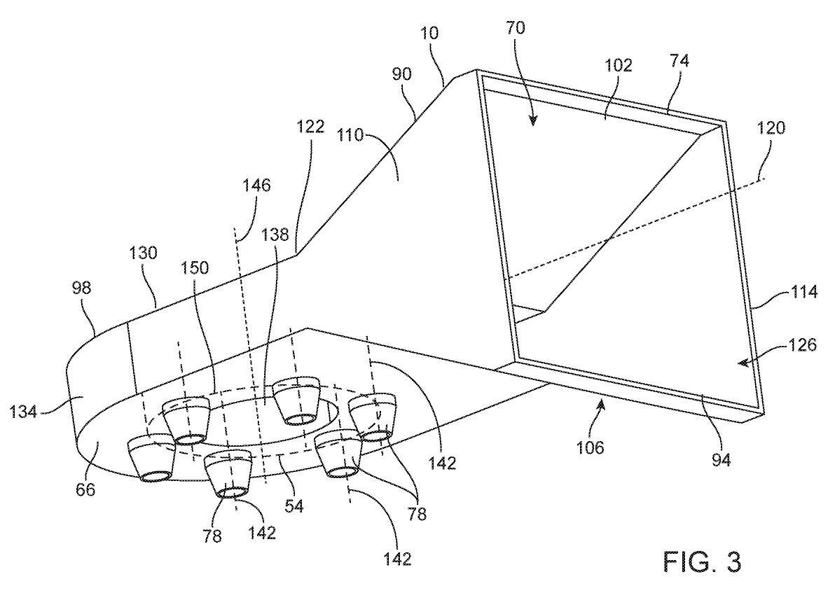

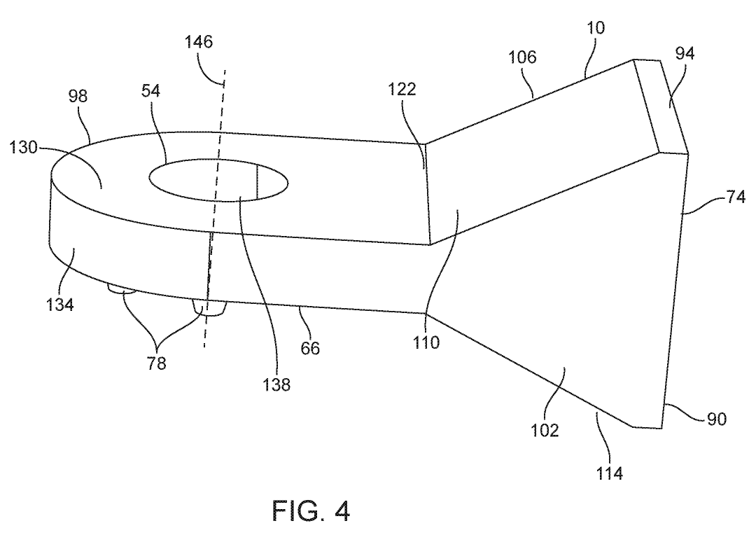

With reference to FIGS. 3-5, the stator cap 10 has a converging/diverging portion 90, depending on the direction of airflow. It should be understood that the converging/diverging portion 90 is a converging portion (e.g., the passage 70 tapers) for an airflow in the first direction A1 and the converging/diverging portion 90 is a diverging portion (e.g., the passage 70 expands) for an airflow in the second direction A2. Unless otherwise noted, uses of “converging portion” and “diverging portion” are interchangeable and refer to converging/diverging portion 90. The converging portion 90 includes a first port 74 positioned at the first end 94 of the converging portion 90 and a manifold portion 98 including the second port 78 and defining the accommodation space 54. The open first end 94 of the converging portion 90 defines the first port 74 and allows air to enter the stator cap 10. The converging portion 90 has first and second walls 102, 106 (e.g., upper and lower walls as shown in the figures) coupled by third and fourth walls 110, 114 (e.g., front and rear walls, as shown in the figures) that define the portion of the passage 70 extending through the converging portion 90. The portion of the passage 70 through the converging portion 90 has a first port axis 120 extending along the passage 70. The side cross-section 118 (FIG. 2, partially shown in FIG. 5) between the upper and lower walls 102, 106 of the converging portion 90 gradually decreases (i.e., narrows) from the first port 74 to the junction 122 of the converging portion 90 and the manifold portion 98. In the present embodiment, the reduction in the side cross-section 118 is a linear taper. In other embodiments, the reduction in cross-section may follow a curved taper. The top cross-section defined between the front and rear walls 110, 114 of the converging portion 90 (e.g., the distance between the front and rear walls 110, 114) remains constant between the first port 74 and the junction 122 of the converging portion 90 and the manifold portion 98. The end cross-section 126, that is, the cross-section of the first port 74, is a square shape. In other embodiments, the end cross-section of the first port 74 could be another shape (e.g., round, oblong, trapezoidal, abstract, etc.).

The manifold portion 98 has a first, upper wall 130 and the second, lower wall 66, coupled by a first, outer, side wall 134 and a second, inner, side wall 138. The inner side wall 138 defines the accommodation space 54. The upper and lower walls 130, 66 have a D-shaped profile. The second port 78 is formed on the second, lower wall 66. Each discrete port of the second port 78 has a frustoconical shape extending from the second, lower wall 66. Each discrete port of the second port 78 defines a second port axis 142 extending along each discrete port of the second port 78. Each second port axis 142 is perpendicular to the first port axis 120. The discrete ports of the second port 78 are positioned radially equidistantly from an axis 146 defined by the accommodation space 54 and are spaced equidistantly about a circle 150 having a constant radius relative to the axis 146 of the accommodating space 54, such that the accommodation space 54 is centrally located between the ports of the second port 78. In other embodiments, the second port axis may be positioned at a different angle relative to the inlet axis. The ports of the second port may be formed as having a different geometry than a frustoconical shape. In the present embodiment, the number of ports of the second outlet 78 corresponds to the number of stator coils 42. In other embodiments, the number of discrete ports of the second port 78 may be less than or greater than the number of stator coils 42.

Although the invention has been described in detail with reference to certain preferred embodiments, variations and modifications exist within the scope and spirit of one or more independent aspects of the invention as described. Various features of the invention are set forth in the following claims.

What is claimed is:

1. An electric motor comprising:
a stator assembly including a stator core having a plurality of stator teeth and a plurality of stator coils, each stator coil wound about one of the stator teeth;
a rotor assembly positioned within the stator assembly and rotatable relative thereto; and
a stator cap coupled to the stator assembly and configured to direct an airflow through the stator assembly, the stator cap including a passage having a first port and a second port, the second port facing the stator assembly, the airflow is directed through the passage in a first direction from the first port to the second port or in a second direction from the second port to the first port.

2. The electric motor of claim 1, wherein the airflow is directed from the first port to the second port and toward the stator assembly.

3. The electric motor of claim 1, wherein the second port includes a plurality of discrete ports, each of the discrete ports corresponding to one of the stator coils.

4. The electric motor of claim 3, wherein each of the discrete ports is directed to one of the stator coils.

5. The electric motor of claim 4, wherein the stator cap includes an accommodation space centrally located between the discrete ports, and wherein the electric motor further comprises a rotor bearing rotatably supporting the rotor assembly and positioned within the accommodation space.

6. The electric motor of claim 1, further comprising a fan configured to generate the airflow directed through the stator cap.

7. The electric motor of claim 1, wherein the stator cap includes a filter configured to reduce particulates in the airflow, the filter positioned between the first port and the second port.

8. An electric motor comprising:
a stator assembly including a stator core having a plurality of stator coils;
a rotor assembly positioned within the stator assembly and rotatable relative thereto; and
a stator cap coupled to the stator assembly and configured to receive an airflow, the stator cap including a plurality of ports for directing the airflow toward the stator assembly.

9. The electric motor of claim 8, wherein the electric motor further comprises a fan coupled to the stator cap and configured to generate the airflow.

10. The electric motor of claim 9, wherein the fan is operable in a first rotational direction to generate the airflow in a first direction through the stator cap and toward the stator coils, and in a second rotational direction to generate the airflow in a second direction through the stator assembly and into the stator cap.

11. The electric motor of claim 8, wherein the ports are disposed radially equidistantly about a circle having a constant radius.

12. The electric motor of claim 11, wherein each port is directed toward a stator coil.

13. The electric motor of claim 8, wherein each of the ports has a frustoconical shape extending from a lower wall of the stator cap toward the stator assembly.

14. The electric motor of claim 8, wherein the stator cap defines an accommodation space that is configured to receive a portion of the rotor assembly.

15. The electric motor of claim 14, wherein the accommodation space receives a rotor bearing that rotatably supports rotation of the rotor assembly relative to the stator assembly.

16. The electric motor of claim 15, wherein the accommodation space receives an output shaft coupled to the rotor bearing.

17. An electric motor comprising:
a stator assembly including a stator core having a plurality of stator coils;
a rotor assembly rotatably coupled to the stator assembly; and
a stator cap coupled to the stator assembly and configured to direct an airflow through the stator assembly, the stator cap including a passage having a first port configured to receive the airflow and a second port facing the stator assembly and configured to direct the airflow toward the stator assembly, the second port including a plurality of discrete ports.

18. The electric motor of claim 17, wherein the stator cap includes a converging portion having a cross-section that gradually decreases from the first port toward the second port.

19. The electric motor of claim 18, wherein the converging portion gradually decreases between an upper wall and a lower wall of the converging portion, and wherein a distance between a front wall and a rear wall of the converging portion remains constant.

20. The electric motor of claim 19, wherein the converging portion decreases linearly.
